(19) United States
(12) Patent Application Publication
(10) Pub. No.: US 2011/0008078 A1
(43) Pub. Date: Jan. 13, 2011

(54) IMAGE FORMING APPARATUS AND IMAGE FORMING METHOD

(75) Inventors: Masashi Takahashi, Kanagawa-ken (JP); Minoru Yoshida, Tokyo-to (JP); Takeshi Watanabe, Kanagawa-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/826,046

(22) Filed: Jun. 29, 2010

Related U.S. Application Data
(60) Provisional application No. 61/223,861, filed on Jul. 8, 2009.

(51) Int. Cl. G03G 15/01

(52) U.S. Cl. 399/302

(57) ABSTRACT

According to one embodiment, an image forming apparatus includes a first image forming unit, a second image forming unit, and an intermediate transfer medium. The first image forming unit includes at least one image bearing member on which a first image is formed. The second image forming unit includes an image bearing member on which a second image is formed. The first image is primarily transferred onto the intermediate transfer medium. When the intermediate transfer medium is moved to a first position, the first image is secondarily transferred onto the image bearing member of the second image forming unit and tertiarily transferred onto a transfer medium from the image bearing member. When the intermediate transfer medium is moved to a second position, the second image is transferred onto the transfer medium from the image bearing member of the second image forming unit.

### CROSS-REFERENCE TO RELATED APPLICATION

This application claims the benefit of U.S. Provisional Application No. 61/223,861 filed on Jul. 8, 2009, the entire contents of which are incorporated herein by reference.

### FIELD

Embodiments described herein relate generally to an image forming apparatus including a color-image forming unit and a monochrome-image forming unit and an image forming method for the image forming apparatus.

### BACKGROUND

Jpn. Pat. Appln. KOKAI Publication No. 2005-156776 discloses an image forming apparatus in which plural color-image forming units and a monochrome-image forming unit are arrayed in tandem. In the image forming apparatus of this type, the color-image forming units and the monochrome-image forming unit respectively include photoconductive drums on which toner images are formed. The photoconductive drums of the color-image forming units and the photoconductive drum of the monochrome-image forming unit are arrayed on an intermediate transfer belt configured to travel in one direction. The intermediate transfer belt is pressed against the respective photoconductive drums via plural primary transfer rollers.

When the image forming apparatus is in a color printing mode, color toner images formed on the photoconductive drums of the color-image forming units and a monochrome toner image formed on the photoconductive drum of the monochrome-image forming unit are primarily transferred onto the intermediate transfer belt. The toner images transferred onto the intermediate transfer belt to be superimposed one on top of another are secondarily transferred onto a sheet from the intermediate transfer belt.

When the image forming apparatus is in a monochrome printing mode, the pressing of the intermediate transfer belt against the photoconductive drums of the color-image forming units is released. Therefore, the photoconductive drums of the color-image forming units not involved in the formation of the monochrome toner image and the intermediate transfer belt are separated from each other. As a result, the intermediate transfer belt is pressed against only the photoconductive drum of the monochrome-image forming unit. The monochrome toner image formed on the photoconductive drum is transferred onto a sheet via the intermediate transfer belt.

With the image forming apparatus in the past, in the monochrome printing mode, the rotation of the photoconductive drums of the color-image forming units not involved in the formation of the monochrome toner image can be stopped. At the same time, in developing devices of the color-image forming units, agitating members configured to agitate toners can be stopped to suppress deterioration in the toners.

However, the intermediate transfer belt is moving in both the monochrome printing mode and the color printing mode and cannot be stopped. As a result, a load on the intermediate transfer belt cannot be prevented from increasing and the life of the intermediate transfer belt is reduced.

### BRIEF DESCRIPTION OF THE DRAWINGS

FIG. 1 is a schematic side view of a color-image forming apparatus according to a first embodiment;

FIG. 2 is a side view of a state in which an intermediate transfer belt is set in contact with photoconductive drums of color-image forming units and a photoconductive drum of a monochrome-image forming unit in the first embodiment;

FIG. 3 is a side view of a state in which the intermediate transfer belt is separated from the photoconductive drum of the monochrome-image forming unit in the first embodiment;

FIG. 4 is a sectional view of the intermediate transfer belt; and

FIG. 5 is a side view of a state in which an intermediate transfer belt is separated from a photoconductive drum of a monochrome-image forming unit in a second embodiment.

### DETAILED DESCRIPTION

In general, according to one embodiment, an image forming apparatus includes: a first image forming unit, a second image forming unit, and an intermediate transfer medium. The first image forming unit includes at least one image bearing member on which a first image is formed. The second image forming unit includes an image bearing member on which a second image is formed. The first image is primarily transferred onto the intermediate transfer medium from the image bearing member of the first image forming unit. The intermediate transfer medium is movable between a first position where the intermediate transfer medium comes into contact with the image bearing member of the second image forming unit and a second position where the intermediate transfer medium separates from the image bearing member of the second image forming unit. When the intermediate transfer medium is moved to the first position, the first image primarily transferred onto the intermediate transfer medium is secondarily transferred onto the image bearing member of the second image forming unit and tertiarily transferred onto a transfer medium from the image bearing member. When the intermediate transfer medium is moved to the second position, the operation of the first image forming unit and the intermediate transfer medium is stopped. The second image formed on the image bearing member of the second image forming unit is transferred onto the transfer medium from the image bearing member.

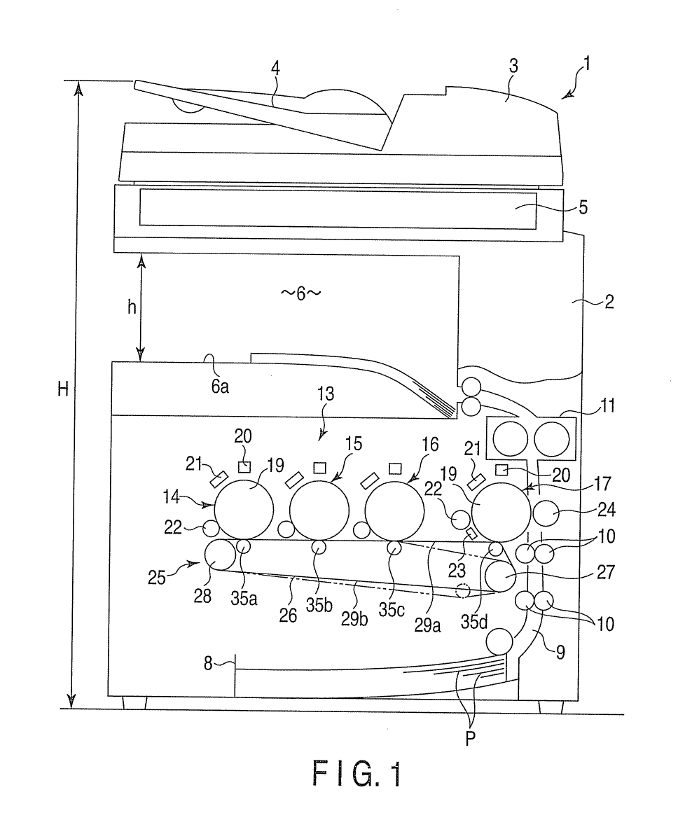

A first embodiment is explained below with reference to FIGS. 1 to 4.

FIG. 1 is a schematic side view of an image forming apparatus 1 of an intra-body discharge type. The image forming apparatus 1 includes a box-shaped apparatus body 2. A scanner 3 configured to optically read character information from an original document and an automatic document feeder 4 configured to feed the original document into the scanner 3 are provided at the upper end of the apparatus body 2. A control panel 5 is provided on the front surface of the scanner 3. The control panel 5 includes, for example, an operation panel for operating the image forming apparatus 1 and a display configured to display an operation state of the image forming apparatus 1.

A sheet discharge section 6 is provided in the apparatus body 2. The sheet discharge section 6 is defined by spaces opened on the front surface and a side surface of the apparatus body 2 and located below the scanner 3. A paper feeding cassette 8 is provided on the bottom of the apparatus body 2. The paper feeding cassette 8 stores plural sheets P. The sheets P are an example of the transfer medium. The paper feeding cassette 8 is connected to the sheet discharge section 6 via a carrying path 9. The carrying path 9 is a path for leading the sheets P stored in the paper feeding cassette 8 to the sheet discharge section 6 one by one. The carrying path 9 is erected in the inside of the apparatus body 2. The sheet P led from the carrying path 9 to the sheet discharge section 6 is stacked on a bottom surface 6a of the sheet discharge section 6. Plural paper feeding rollers 10 and a fixing device 11 are provided on the carrying path 9. The fixing device 11 is located at the upper end of the carrying path 9.

As shown in FIG. 1, an image forming mechanism 13 is arranged on the inside of the apparatus body 2. The image forming mechanism 13 includes a first color-image forming unit 14 configured to form a cyan image, a second color-image forming unit 15 configured to form a magenta image, a third-color-image forming unit 16 configured to form a yellow image, and a monochrome-image forming unit 17 configured to form a monochrome image. Each of the first to third color-image forming units 14, 15, and 16 is an example of the first image forming unit. The cyan image, the magenta image, and the yellow image correspond to the first image. The monochrome-image forming unit 17 is an example of the second image forming unit. The monochrome image corresponds to the second image. The first to third color-image forming units 14, 15, and 16 and the monochrome-image forming unit 17 are arrayed in tandem along the width direction of the apparatus body 2.

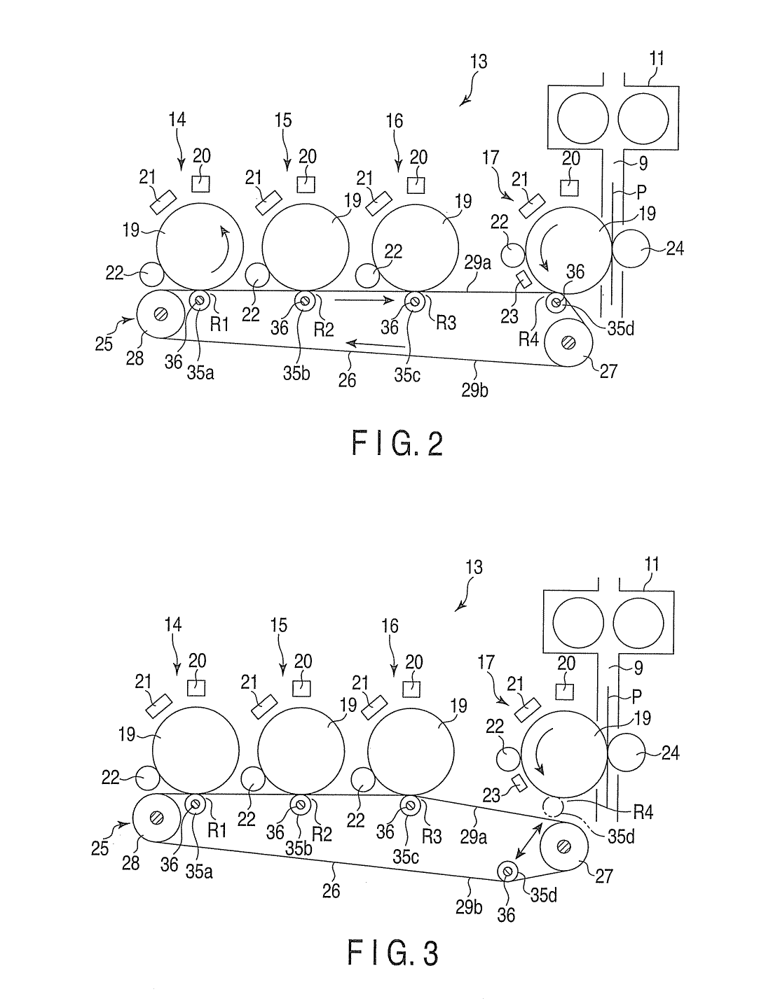

As shown in FIG. 2, each of the first to third color-image forming units 14, 15, and 16 includes a photoconductive drum 19, a charging device 20, an exposing device 21, and a developing device 22. The photoconductive drum 19 is an example of the image bearing member. The photoconductive drum 19 is a cylinder having a diameter of, for example, 60 mm. The photoconductive drum 19 is rotated in a direction of an arrow A in FIG. 2 by a driving source such as a motor. The charging device 20, the exposing device 21, and the developing device 22 are arranged around the photoconductive drum 19 to be opposed to the outer circumferential surface of the photoconductive drum 19. The charging device 20 uniformly negatively charges the photoconductive drum 19 with, for example, a Scorotron system. The photoconductive drum 19 may be negatively charged by using, instead of the charging device 20, a conductive roller, a conductive brush, or a conductive blade set in contact with the outer circumferential surface of the photoconductive drum 19.

The exposing device 21 is provided further on a downstream side along a rotating direction of the photoconductive drum 19 than the charging device 20. The exposing device 21 irradiates light corresponding to image information on the outer circumferential surface of the photoconductive drum 19. As a result, an electrostatic latent image is formed on the outer circumferential surface of the photoconductive drum 19. The developing device 22 is provided further on the downstream side along the rotating direction of the photoconductive drum 19 than the exposing device 21. The developing device 22 develops, using a toner of a color that should be developed, the electrostatic latent image formed on the outer circumferential surface of the photoconductive drum 19. In this embodiment, the developing device 22 of the first color-image forming unit 14 develops the electrostatic latent image using a yellow toner. The developing device 22 of the second color-image forming unit 15 develops the electrostatic latent image using a magenta toner. The developing device 22 of the third color-image forming unit 16 develops the electrostatic latent image using a cyan toner.

The monochrome-image forming unit 17 has a configuration same as that of the first to third color-image forming units 14, 15, and 16. Therefore, components same as those of the first to third color-image forming units 14, 15, and 16 are denoted by the same reference numerals and signs and explanation of the components is omitted. The monochrome-image forming unit 17 is different from the first to third color-image forming units 14, 15, and 16 in that the monochrome-image forming unit 17 includes a dedicated charge removing device 23. The charge removing device 23 is provided further on the downstream side along the rotating direction of the photoconductive drum 19 than the developing device 22. The developing device 22 of the monochrome-image forming unit 17 develops the electrostatic latent image using a black toner.

As shown in FIG. 2, in the photoconductive drum 19 of the monochrome-image forming unit 17, a part of the outer circumferential surface thereof is exposed on the carrying path 9. The photoconductive drum 19 is opposed to a transfer roller 24 on the lower side of the fixing device 11. The sheet P carried along the carrying path 9 is led to the fixing device 11 through between the transfer roller 24 and the photoconductive drum 19.

According to this embodiment, each of the exposing devices 21 of the first to third color-image forming units 14, 15, and 16 and the monochrome-image forming unit 17 includes an optical system configured to expose the photoconductive drum 19 to light. The optical system is independently provided for each of the first to third color-image forming units 14, 15, and 16 and the monochrome-image forming unit 17. The optical system has an optical head. The optical head includes plural light emitting elements. It is desirable to use light emitting diodes or organic ELs as the light emitting elements. The light emitting elements are arrayed in the axis direction of the photoconductive drum 19.

As the exposing device, it is possible to use an optical system in which a laser beam source and a MEMS (micro electro mechanical system) mirror configured to scan light emitted by the laser beam source in the axis direction of the photoconductive drum are combined. The MEMS mirror includes a mirror formed on monocrystal silicon and a comb-shaped driving section moved up and down by static electricity. The mirror is driven by the comb-shaped driving section. The laser beam source irradiates a laser beam corresponding to image information on the mirror.

An intermediate transfer device 25 is arranged below the first to third color-image forming units 14, 15, and 16 and the monochrome-image forming unit 17. The intermediate transfer device 25 includes an intermediate transfer belt 26. The intermediate transfer belt 26 is an example of the intermediate transfer medium. The intermediate transfer belt 26 is endlessly laid over between a driving roller 27 and a driven roller 28. To prevent the intermediate transfer belt 26 from slipping on the driving roller 27 and the driven roller 28, sufficient tension is applied to the intermediate transfer belt 26. A distance between the driving roller 27 and the driven roller 28 is about 300 mm. The intermediate transfer belt 26 has a width dimension equivalent to the total length of the photoconductive drum 19.

The intermediate transfer belt 26 includes a first traveling path 29a and a second traveling path 29b. The first traveling path 29a travels in the lateral direction from the driven roller 28 to the driving roller 27. The second traveling path 29b travels in the lateral direction from the driving roller 27 to the driven roller 28 below the first traveling path 29a.

The first to third color-image forming units 14, 15, and 16 and the monochrome-image forming unit 17 are arrayed on the first traveling path 29a of the intermediate transfer belt 26. Specifically, the first color-image forming unit 14, the second color-image forming unit 15, the third color-image forming unit 16, and the monochrome-image forming unit 17 are arrayed in order from the upstream end to the downstream end along the traveling direction of the first traveling path 29a.

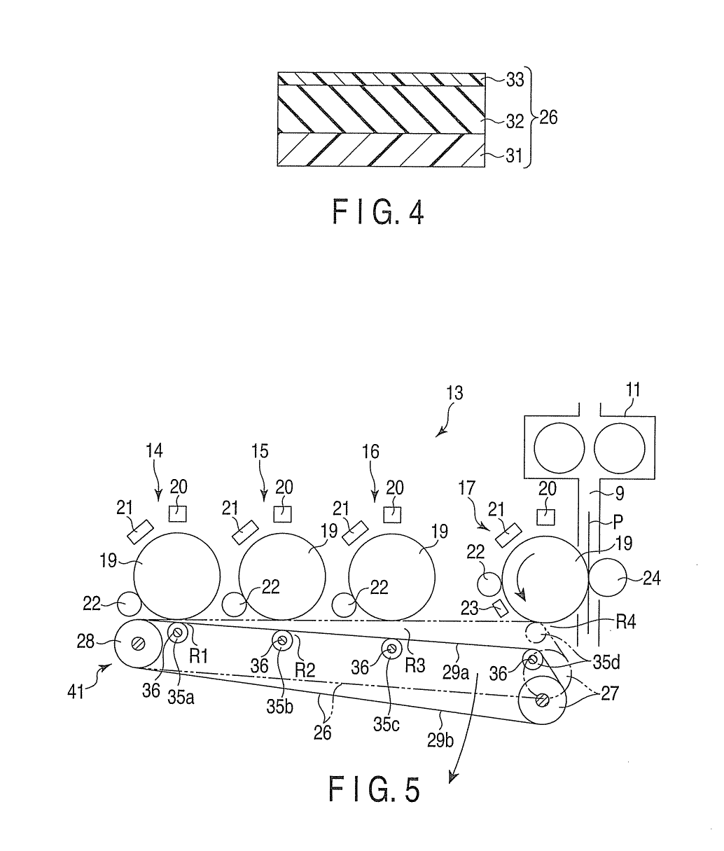

As shown in FIG. 4, the intermediate transfer belt 26 has a low-resistance layer and a high-resistance layer laminated on the low-resistance layer. Specifically, the intermediate transfer belt 26 adopts a multilayer structure including a base material layer 31, an intermediate layer 32, and a surface layer 33. The base material layer 31 is a component set in contact with the driving roller 27 and the driven roller 28 and formed of, for example, polyimide. The resistance of the surface of the base material layer 31 is 10⁹ Ω/square and the thickness of the base material layer 31 is 80 μm. The intermediate layer 32 is formed of, for example, conductive urethane rubber in which carbon is dispersed. The intermediate layer 32 is laminated on the base material layer 31. The resistance of the surface of the intermediate layer 32 is 10¹² Ω/square and the thickness of the intermediate layer 32 is 160 μm. The surface layer 33 is a component that comes into contact with the outer circumferential surface of the photoconductive drum 19. The surface layer 33 is formed of fluorine resin having electricity insulating properties taking into account toner peeling performance and durability. The surface layer 33 is laminated on the intermediate layer 32. The thickness of the surface layer 33 is 3 μm. Therefore, the intermediate transfer belt 26 is elastically deformable in the thickness direction because of the presence of the intermediate layer 32. Adhesion of the intermediate transfer belt 26 to the outer circumferential surface of the photoconductive drum 19 is improved.

As shown in FIG. 2, first to fourth transfer rollers 35a, 35b, 35c, and 35d are arranged on the lower side of the first traveling path 29a of the intermediate transfer belt 26. Each of the first to fourth transfer rollers 35a, 35b, 35c, and 35d includes, for example, a foamed urethane roller having conductivity. The outer diameter of the first to fourth transfer rollers 35a, 35b, 35c, and 35d is 18 mm. Each of the first to fourth transfer rollers 35a, 35b, 35c, and 35d has a cored bar having an outer diameter of 10 mm. The cored bar is connected to a constant voltage DC power supply. The electric resistance between the cored bar and the formed urethane roller is about 10⁶Ω.

The first transfer roller 35a is opposed to the photoconductive drum 19 of the first color-image forming unit 14 across the first traveling path 29a of the intermediate transfer belt 26. The second transfer roller 35b is opposed to the photoconductive drum 19 of the second color-image forming unit 15 across the first traveling path 29a of the intermediate transfer belt 26. The third transfer roller 35c is opposed to the photoconductive drum 19 of the third color-image forming unit 16 across the first traveling path 29a of the intermediate transfer belt 26. The fourth transfer roller 35d is opposed to the photoconductive drum 19 of the monochrome-image forming unit 17 across the first traveling path 29a of the intermediate transfer belt 26.

The first transfer roller 35a forms a first transfer area R1 on the first traveling path 29a of the intermediate transfer belt 26 in cooperation with the photoconductive drum 19 of the first color-image forming unit 14. The second transfer roller 35b forms a second transfer area R2 on the first traveling path 29a of the intermediate transfer belt 26 in cooperation with the photoconductive drum 19 of the second color-image forming unit 15. The third transfer roller 35c forms a third transfer area R3 on the first traveling path 29a of the intermediate transfer belt 26 in cooperation with the photoconductive drum 19 of the third color-image forming unit 16. The fourth transfer roller 35d forms a fourth transfer area R4 on the first traveling path 29a of the intermediate transfer belt 26 in cooperation with the photoconductive drum 19 of the monochrome-image forming unit 17. The first to fourth transfer areas R1 to R4 are arranged side by side at intervals from one another from the upstream end to the downstream end along the traveling direction of the first traveling path 29a.

Each of the first to fourth transfer rollers 35a, 35b, 35c, and 35d has a roller shaft 36 coaxial with the cored bar. Urging means such as springs are provided at both ends of the roller shaft 36. The urging means elastically urge the first to fourth transfer rollers 35a, 35b, 35c, and 35d to the photoconductive drums 19 opposed thereto, respectively.

As a result, the first to fourth transfer rollers 35a, 35b, 35c, and 35d come into contact with the base material layer 31 of the intermediate transfer belt 26. The surface layer 33 of the intermediate transfer belt 26 is pressed against the outer circumferential surfaces of the photoconductive drums 19 of the first to third color-image forming units 14 to 16 and the outer circumferential surface of the photoconductive drum 19 of the monochrome-image forming unit 17. According to this embodiment, the magnitude of urging force applied to the first to fourth transfer rollers 35a, 35b, 35c, and 35d is, for example, 600 gft.

A component that presses the intermediate transfer belt 26 against the outer circumferential surface of the photoconductive drum 19 is not limited to the foamed urethane roller having conductivity. For example, a conductive rubber blade, a conductive brush, or a conductive sheet may be used instead of the foamed urethane roller. As the conductive sheet, for example, a rubber material in which carbon is dispersed or a resin film, a rubber material such as a silicone rubber or ethylene propylene rubber (EPDM), or a resin material such as polycarbonate can be used. In particular, as the conductive sheet, it is desirable to use a material having volume resistance of 10⁵ Ωcm to 10⁷ Ωcm.

The fourth transfer roller 35d corresponding to the photoconductive drum 19 of the monochrome-image forming unit 17 is adjacent to the driving roller 27 configured to drive the intermediate transfer belt 26. The fourth transfer roller 35d is an example of the mode switching member and movable between the first position and the second position.

In FIG. 2, a state in which the fourth transfer roller 35d is moved to the first position is shown. In the first position, the fourth transfer roller 35d is pushed up to the photoconductive drum 19 of the monochrome-image forming unit 17 by the urging means and presses the first traveling path 29a of the intermediate transfer belt 26 against the photoconductive drum 19. In other words, when the fourth transfer roller 35d is moved to the first position, the first traveling path 29a of the intermediate transfer belt 26 is nipped between the fourth transfer roller 35d and the outer circumferential surface of the photoconductive drum 19 of the monochrome-image forming unit 17. In the state in which the fourth transfer roller 35d is moved to the first position, the image forming apparatus 1 changes to a color printing mode.

In FIG. 3, a state in which the fourth transfer roller 35d is moved to the second position is shown. In the second position, the fourth transfer roller 35d retracts to below the photoconductive drum 19 of the monochrome-image forming unit 17 and separates from the first traveling path 29a of the intermediate transfer belt 26. As a result, the push-up of the first traveling path 29a of the intermediate transfer belt 26 by the fourth transfer roller 35d is released and the first traveling path 29a is separated from the photoconductive drum 19 of the monochrome-image forming unit 17. In the state in which the fourth transfer roller 35d is moved to the second position, the image forming apparatus 1 changes to a monochrome printing mode.

A process for forming a color image using the image forming apparatus 1 is explained below.

When an instruction for forming a color image is input to the control panel 5 of the image forming apparatus 1, the color printing mode starts. In the color printing mode, the fourth transfer roller 35d opposed to the photoconductive drum 19 of the monochrome-image forming unit 17 is held in the first position shown in FIG. 2. The photoconductive drums 19 of the first to third color-image forming units 14, 15 and 16 and the photoconductive drum 19 of the monochrome-image forming unit 17 start rotation. The intermediate transfer belt 26 starts traveling via the driving roller 27. The surface layer 33 of the intermediate transfer belt 26 comes into contact with the outer circumferential surfaces of the photoconductive drums 19 for color and monochrome via the first to fourth transfer rollers 35a, 35b, 35c, and 35d.

The charging devices 20 of the image forming units 14, 15, 16, and 17 uniformly charge the outer circumferential surfaces of the photoconductive drums 19 opposed thereto, respectively, to about −600 V. The exposing devices 21 irradiate light corresponding to image information optically read by the scanner 3 on the outer circumferential surfaces of the photoconductive drums 19 opposed thereto, respectively, to form electrostatic latent images on the outer circumferential surfaces of the photoconductive drums 19. The developing devices 22 develop the electrostatic latent images formed on the outer circumferential surfaces of the photoconductive drums 19 using toners. As a result, the electrostatic latent images on the outer circumferential surfaces of the four photoconductive drums 19 are visualized as toner images of the four colors.

Bias voltage of about +1000 V is applied to the first transfer roller 35a at timing when the yellow toner image formed on the photoconductive drum 19 of the first color-image forming unit 14 reaches the first transfer area R1 on the intermediate transfer belt 26. Therefore, a transfer electric field is formed between the first transfer roller 35a and the photoconductive drum 19. The yellow toner image formed on the photoconductive drum 19 is primarily transferred onto the intermediate transfer belt 26 according to the transfer electric field. The yellow toner image primarily transferred onto the intermediate transfer belt 26 moves from the first transfer area R1 to the second transfer area R2 according to the traveling of the intermediate transfer belt 26.

Subsequently, the bias voltage of about +1000 V is applied to the second transfer roller 35b at timing when the magenta toner image formed on the photoconductive drum 19 of the second color-image forming unit 15 reaches the second transfer area R2 on the intermediate transfer belt 26. Therefore, a transfer electric field is formed between the second transfer roller 35b and the photoconductive drum 19. The magenta toner image formed on the photoconductive drum 19 is primarily transferred onto the intermediate transfer belt 26 to be superimposed on the yellow toner image according to the transfer electric field. The yellow toner image and the magenta toner image transferred onto the intermediate transfer belt 26 to be superimposed move from the second transfer area R2 to the third transfer area R3 according to the traveling of the intermediate transfer belt 26.

Further, the bias voltage of about +1000 V is applied to the third transfer roller 35c at timing when the cyan toner image formed on the photoconductive drum 19 of the third color-image forming unit 16 reaches the third transfer area R3 on the intermediate transfer belt 26. Therefore, a transfer electric field is formed between the third transfer roller 35c and the photoconductive drum 19. The cyan toner image formed on the photoconductive drum 19 is primarily transferred onto the intermediate transfer belt 26 to be superimposed on the yellow toner image and the magenta toner image according to the transfer electric field. As a result, a color toner image is formed on the intermediate transfer belt 26.

The color toner image moves from the third transfer area R3 to the fourth transfer area R4 according to the traveling of the intermediate transfer belt 26. In the fourth transfer area R4, the photoconductive drum 19 of the monochrome-image forming unit 17 is set in contact with the intermediate transfer belt 26. Therefore, bias voltage is applied to the fourth transfer roller 35d at timing when the color toner image formed on the intermediate transfer belt 26 reaches the fourth transfer area R4. In this embodiment, since toners having minus polarity are used, bias voltage of −1800 V is applied to the fourth transfer roller 35d.

As a result, the color toner image formed on the intermediate transfer belt 26 is secondarily transferred onto the outer circumferential surface of the photoconductive drum 19 of the monochrome-image forming unit 17. The color toner image transferred onto the photoconductive drum 19 of the monochrome-image forming unit 17 is superimposed on the monochrome toner image formed on the outer circumferential surface of the photoconductive drum 19 of the monochrome-image forming unit 17. Therefore, the toner images of the four colors are superimposed one on top of another on the outer circumferential surface of the photoconductive drum 19 of the monochrome-image forming unit 17.

As a preferred example, the monochrome-image forming unit 17 in this embodiment includes the charge removing device 23. When the color toner image transferred onto the intermediate transfer belt 26 to be superimposed is secondarily transferred onto the outer circumferential surface of the photoconductive drum 19, the charge removing device 23 removes the potential of the outer circumferential surface of the photoconductive drum 19 to equalize the potential of the photoconductive drum 19.

When the color toner image is secondarily transferred onto the photoconductive drum 19 of the monochrome-image forming unit 17, the sheet P fed from the paper feeding cassette 8 to the carrying path 9 is led to between the photoconductive drum 19 of the monochrome-image forming unit 17 and the transfer roller 24. When the sheet P passes between the photoconductive drum 19 and the transfer roller 24, the toner images of the four colors superimposed on the photoconductive drum 19 of the monochrome-image forming unit 17 are tertiarily transferred onto the sheet P from the photoconductive drum 19. As a result a full-color image is formed on the sheet P. The full-color image is fixed on the sheet P by the fixing device 11. The sheet P having the full-color image fixed thereon is discharged to the sheet discharge section 6 in the apparatus body 2 from the carrying path 9.

On the other hand, when an instruction for forming a monochrome image is input to the control panel 5 of the image forming apparatus 1, the monochrome printing mode starts. In the monochrome printing mode, the fourth transfer roller 35d moves from the first position to the second position. Therefore, since the push-up of the intermediate transfer belt 26 by the fourth transfer roller 35d is released, the first traveling path 29a of the intermediate transfer belt 26 separates from the photoconductive drum 19 of the monochrome-image forming unit 17.

In this embodiment, the fourth transfer roller 35d comes into contact with the second traveling path 29b of the intermediate transfer belt 26 and presses the second traveling path 29b in a direction away from the first traveling path 29a. Therefore, even if the first traveling path 29a of the intermediate transfer belt 26 separates from the photoconductive drum 19 of the monochrome-image forming unit 17, the tension applied to the intermediate transfer belt 26 can be maintained.

In addition, in the monochrome printing mode, the operation of the first to third color-image forming units 14, 15, and 16 and the intermediate transfer belt 26 is stopped. As a result, in the monochrome printing mode, a monochrome toner image is formed on the outer circumferential surface of the photoconductive drum 19 of the monochrome-image forming unit 17. The monochrome toner image is transferred onto the sheet P from the photoconductive drum 19 when the sheet P passes between the photoconductive drum 19 and the transfer roller 24. Therefore, a monochrome image is formed on the sheet P. The monochrome image is fixed on the sheet P by the fixing device 11. The sheet P having the monochrome image fixed thereon is discharged to the sheet discharge section 6 in the apparatus body 2 from the carrying path 9.

According to such the first embodiment, when the image forming apparatus 1 is in the monochrome printing mode, the monochrome toner image formed on the photoconductive drum 19 of the monochrome-image forming unit 17 is directly transferred from the photoconductive drum 19 onto the sheet P. Therefore, the operation of the first to third color-image forming units 14, 15, and 16 not involved in the formation of the monochrome image and the intermediate transfer belt 26 can be stopped.

This makes it possible to reduce a load on the intermediate transfer belt 26 and suppress deterioration of the intermediate transfer belt 26.

The intermediate transfer belt 26 is elastically deformable in the thickness direction because of the presence of the intermediate layer 32 made of rubber. The elastic intermediate transfer belt 26 has satisfactory adhesion to the outer circumferential surface of the photoconductive drum 19. Therefore, when the color toner image formed on the outer circumferential surface of the photoconductive drum 19 is primarily transferred onto the intermediate transfer belt 26, the color toner image can be efficiently uniformly transferred onto the intermediate transfer belt 26 from the photoconductive drum 19. Similarly, when the color toner image primarily transferred onto the intermediate transfer belt 26 is secondarily transferred onto the photoconductive drum 19 of the monochrome-image forming unit 17, the color toner image can be efficiently uniformly transferred onto the photoconductive drum 19 from the intermediate transfer belt 26. Therefore, transfer characteristic in primarily and secondarily transferring the color toner image is satisfactory.

According to this embodiment, the exposing devices 21 configured to form electrostatic latent images on the photoconductive drums 19 of the first to third color-image forming units 14, 15, and 16 and the monochrome-image forming unit 17 have the optical heads including the light emitting diodes or the organic ELs. The exposing devices 21 are provided independently for the respective image forming units 14, 15, 16, and 17 to be located around the photoconductive drums 19 of the image forming units 14, 15, 16, and 17. Therefore, unlike the laser optical system unit in the past configured to allocate a laser beam to plural photoconductive drums using a polygon mirror, it is unnecessary to layout the image forming units 14, 15, 16, and 17 taking into account a path of the laser beam. Therefore, a degree of freedom in laying out the image forming units 14, 15, 16, and 17 is increased. An arrangement interval of the image forming units 14, 15, 16, and 17 can be narrowed to a limit.

In addition, in this embodiment, it is unnecessary to secure, in the inside of the apparatus body 2, a space for housing the laser optical system unit. As a result, for example, in the image forming apparatus 1 of the intra-body discharge type shown in FIG. 1, the position of the bottom surface 6a of the sheet discharge section 6 can be lowered to sufficiently secure a height dimension h of the sheet discharge section 6. Therefore, since the sheet discharge section 6 is widened, it is possible to easily perform work for taking out the sheet P discharged onto the bottom surface 6a of the sheet discharge section 6.

Further, if the height dimension h of the sheet discharge section 6 is equivalent to that in the past, since the space for housing the laser optical system unit is unnecessary, a height dimension H of the image forming apparatus 1 can be reduced. Therefore, the image forming apparatus 1 is reduced in size.

If the laser optical system unit is unnecessary, the polygon mirror and a motor for driving the polygon mirror can be eliminated. The number of components of the image forming apparatus 1 can be reduced. Further, driving sound of the polygon mirror is not emitted, operation sound of the image forming apparatus 1 can be reduced, and power consumption of the image forming apparatus 1 decreases.

A manufacturing process for the optical heads including organic ELs can be simplified compared with that for the optical heads including light emitting diodes. In addition, the organic ELs are more inexpensive than the light emitting diodes. Therefore, the exposing devices 21 mounted with the optical heads including organic ELs contribute to a reduction in cost of the image forming apparatus 1. Further, in the organic ELs, driving current for light emission is small. Therefore, power consumption of the exposing devices 21 can be reduced.

When the optical system in which the laser beam source and the MEMS (micro electro mechanical system) mirror are combined is used as an exposing device, the exposing device can be more reduced in size than the laser optical system unit in the past configured to allocate a laser beam to the plural photoconductive drums using the polygon mirror. Therefore, it is unnecessary to secure a large space for setting the exposing device in the apparatus body 2. The image forming apparatus 1 can be reduced in size. In addition, the polygon mirror and the motor for driving the polygon mirror, which are the essential components of the laser optical system unit in the past, can be eliminated. The number of components of the image forming apparatus 1 can be reduced. Further, driving sound of the polygon mirror is not emitted, operation sound of the image forming apparatus 1 can be reduced, and power consumption of the image forming apparatus 1 decreases.

FIG. 5 discloses a second embodiment.

The second embodiment is different from the first embodiment in a configuration for bringing the intermediate transfer belt 26 into contact with the photoconductive drum 19 of the monochrome-image forming unit 17 and separating the intermediate transfer belt 26 from the photoconductive drum 19. A basic configuration of the image forming apparatus 1 excluding this configuration is the same as that in the first embodiment. Therefore, in the second embodiment, components same as those in the first embodiment are denoted by the same reference numerals and signs and explanation of the components is omitted.

As shown in FIG. 5, the intermediate transfer belt 26, the driving roller 27, the driven roller 28, and the first to fourth transfer rollers 35a, 35b, 35c, and 35d configure an intermediate transfer device 41. The intermediate transfer device 41 is assembled as one structure. The first to fourth transfer rollers 35a, 35b, 35c, and 35d always maintain a state in which the transfer rollers 35a, 35b, 35c, and 35d are set in contact with the first traveling path 29a of the intermediate transfer belt 26.

The intermediate transfer device 41 can pivot between the first position and the second position with the rotation center of the driven roller 28 as a fulcrum. As indicated by an alternate long and two short dashes line in FIG. 5, in a state in which the intermediate transfer device 41 is pivoted to the first position, the first traveling path 29a of the intermediate transfer belt 26 is pressed against the outer circumferential surfaces of the photoconductive drums 19 of the image forming units 14, 15, 16, and 17 via the first to fourth transfer rollers 35a, 35b, 35c, and 35d. In other words, the first traveling path 29a of the intermediate transfer belt 26 is nipped between the photoconductive drums 19 of the image forming units 14, 15, 16, and 17 and the first to fourth transfer rollers 35a, 35b, 35c, and 35d.

As indicated by a solid line in FIG. 5, in a state in which the intermediate transfer device 41 is pivoted to the second position, the first traveling path 29a of the intermediate transfer belt 26 is separated from the outer circumferential surfaces of the photoconductive drums 19 of the image forming units 14, 15, 16, and 17. Further, when the intermediate transfer device 41 is pivoted to the second position, the operation of the first to third color-image forming units 14, 15, and 16 and the intermediate transfer belt 26 is stopped.

In the second embodiment, the image forming apparatus 1 changes to the color printing mode when the intermediate transfer device 41 is pivoted to the first position. Therefore, color toner images formed on the outer circumferential surfaces of the photoconductive drums 19 of the first to third color-image forming units 14, 15, and 16 are sequentially primarily transferred onto the intermediate transfer belt 26 in the first to third transfer areas R1, R2, and R3. The plural color toner images transferred onto the intermediate transfer belt 26 to be superimposed are secondarily transferred onto the photoconductive drum 19 of the monochrome-image forming unit 17 in the fourth transfer area R4. As a result, the color toner images are superimposed on a monochrome toner image formed on the outer circumferential surface of the photoconductive drum 19 of the monochrome-image forming unit 17.

The toner images of the four colors superimposed one on top of another on the photoconductive drum 19 of the monochrome-image forming unit 17 are tertiarily transferred onto the sheet P from the photoconductive drum 19 when the sheet P passes between the photoconductive drum 19 and the transfer roller 24.

On the other hand, when the intermediate transfer device 41 is pivoted from the first position to the second position, the image forming apparatus 1 changes to the monochrome printing mode. In the monochrome printing mode, the operation of the first to third color-image forming units 14, 15, and 16 and the intermediate transfer belt 26 is stopped and the intermediate transfer belt 26 is separated from the photoconductive drum 19 of the monochrome-image forming unit 17. As a result, the monochrome toner image formed on the outer circumferential surface of the photoconductive drum 19 of the monochrome-image forming unit 17 is directly transferred onto the sheet P from the photoconductive drum 19.

In such the second embodiment, as in the first embodiment, in the monochrome printing mode, the operation of the first to third color-image forming units 14, 15, and 16 not involved in formation of a monochrome image and the intermediate transfer belt 26 can be stopped. Therefore, it is possible to reduce a load on the intermediate transfer belt 26 and suppress deterioration of the intermediate transfer belt 26.

In the first embodiment, the image forming apparatus of the intra-body discharge type having the sheet discharge section in the inside of the apparatus body is representatively explained. However, the image forming apparatus is not limited to the intra-body discharge type. For example, the first embodiment can be carried out in the same manner in an image forming apparatus in which a paper discharge tray projecting to a side of a scanner is provided in an upper part of an apparatus body.

In the first and second embodiments, the color toner images are respectively formed on the photoconductive drums of the first to third color-image forming units. However, plural color toner images may be formed on a photoconductive drum of one color-image forming unit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a first image forming unit including at least one image bearing member on which a first image is formed;
a second image forming unit including an image bearing member on which a second image is formed, the image bearing member transferring the second image onto a transfer medium; and
an intermediate transfer medium onto which the first image formed on the image bearing member of the first image forming unit is primarily transferred, the intermediate transfer medium being movable between a first position where the intermediate transfer medium comes into contact with the image bearing member of the second image forming unit and a second position where the intermediate transfer medium separates from the image bearing member of the second image forming unit,
when the intermediate transfer medium is moved to the first position, the first image primarily transferred onto the intermediate transfer medium is secondarily transferred onto the image bearing member of the second image forming unit and tertiarily transferred onto the transfer medium from the image bearing member, and
when the intermediate transfer medium is moved to the second position, the operation of the first image forming unit and the intermediate transfer medium is stopped and the second image formed on the image bearing member of the second image forming unit is transferred onto the transfer medium from the image bearing member.

2. The apparatus of claim 1, wherein the intermediate transfer medium is an intermediate transfer belt endlessly laid over between a driving roller and a driven roller, the intermediate transfer belt including a first traveling path configured to travel in one direction between the driving roller and the driven roller and a second traveling path configured to travel in a direction opposite to the direction of the first traveling path, and
the image bearing member of the first image forming unit and the image bearing member of the second image forming unit are arrayed on the first traveling path of the intermediate transfer belt.

3. The apparatus of claim 2, further comprising a mode switching member configured to move the first traveling path of the intermediate transfer belt to the first position and the second position.

4. The apparatus of claim 3, wherein the mode switching member is a transfer roller configured to come into contact with the first traveling path of the intermediate transfer belt in a position opposed to the image bearing member of the second image forming unit, and
when the transfer roller nips the first traveling path of the intermediate transfer belt in cooperation with the image bearing member of the second image forming unit, the intermediate transfer belt moves to the first position.

5. The apparatus of claim 4, wherein, when the transfer roller separates from the first traveling path of the intermediate transfer belt, the intermediate transfer belt moves from the first position to the second position.

6. The apparatus of claim 5, wherein, when the transfer roller is moved to the second position, the transfer roller rotatably comes into contact with the second traveling path of the intermediate transfer belt and presses the second traveling path in a direction away from the first traveling path.

7. The apparatus of claim 2, wherein the intermediate transfer belt has a base material layer, an elastic intermediate layer laminated on the base material layer, and a surface layer laminated on the intermediate layer, the surface layer coming into contact with the image bearing member of the first image forming unit and the image bearing member of the second image forming unit.

8. The apparatus of claim 1, wherein each of the first image forming unit and the second image forming unit includes an exposing device configured to form an electrostatic latent image on the image bearing member, the exposing device including an optical system having plural light emitting elements arrayed in a longitudinal direction of the image bearing member.

9. The apparatus of claim 1, wherein each of the first image forming unit and the second image forming unit includes an exposing device configured to form an electrostatic latent image on the image bearing member, the exposing device including an optical system having a MEMS mirror configured to scan a laser beam in a longitudinal direction of the image bearing member.

10. An image forming apparatus comprising:
a first image forming unit including at least one image bearing member on which a first image is formed;
a second image forming unit including an image bearing member on which a second image is formed; and
an intermediate transfer medium onto which the first image formed on the image bearing member of the first image forming unit is primarily transferred, the intermediate transfer medium being movable between a first position where the intermediate transfer medium comes into contact with the image bearing member of the second image forming unit and a second position where the intermediate transfer medium separates from the image bearing member of the second image forming unit, the first image is transferred onto a transfer medium from the image bearing member of the second image forming unit through transfer to the image bearing member of the second image forming unit.

11. An image forming apparatus comprising:
plural color-image forming units respectively having image bearing members on which color images are formed;
a monochrome-image forming unit having an image bearing member on which a monochrome image is formed, the image bearing member transferring the monochrome image onto a transfer medium;
an intermediate transfer belt onto which plural color images formed on the image bearing members of the color-image forming units are primarily transferred, the intermediate transfer belt traveling along an arraying direction of the color-image forming units and the monochrome-image forming unit; and
a mode switching member movable between a first position where the mode switching member presses the intermediate transfer belt against the image bearing member of the monochrome-image forming unit and a second position where the mode switching member separates the intermediate transfer belt from the image bearing member of the monochrome-image forming unit.

12. The apparatus of claim 11, wherein, when the mode switching member is moved to the first position, the color images primarily transferred onto the intermediate transfer belt are secondarily transferred onto the image bearing member of the monochrome-image forming unit and tertiarily transferred onto the transfer medium from the image bearing member and, when the mode switching member is moved to the second position, operation of the color-image forming units and the intermediate transfer belt is stopped and the monochrome image formed on the image bearing member of the monochrome-image forming unit is transferred onto the transfer medium from the image bearing member.

13. The apparatus of claim 11, wherein the mode switching member is a transfer roller set in contact with the intermediate transfer belt in a position opposed to the image bearing member of the monochrome-image forming unit, the transfer roller nipping the intermediate transfer belt between the transfer roller and the image bearing member of the monochrome-image forming unit when the transfer roller is moved to the first position.

14. The apparatus of claim 13, wherein the intermediate transfer belt has a base material layer, an elastic intermediate layer laminated on the base material layer, and a surface layer laminated on the intermediate layer, the surface layer coming into contact with the image bearing members of the color-image forming units and the image bearing member of the monochrome-image forming unit.

15. An image forming method for transferring color images and a monochrome image onto a transfer medium, the method comprising:
in transferring the color images onto the transfer medium, primarily transferring the color image formed on at least one image bearing member of a color-image forming unit onto an intermediate transfer belt; secondarily transferring the color image, which is primarily transferred onto the intermediate transfer belt, onto an image bearing member of the monochrome-image forming unit; and tertiarily transferring the color image, which is secondarily transferred onto the image bearing member of the monochrome-image forming unit, onto the transfer medium from the image bearing member; and
in transferring the monochrome image onto the transfer medium, separating the intermediate transfer belt from the image bearing member of the color-image forming unit and stopping operation of the color-image forming unit and the intermediate transfer belt; and transferring the monochrome image, which is formed on the image bearing member of the monochrome-image forming unit, onto the transfer medium from the image bearing member.

16. The method of claim 15, further comprising, in transferring the color image onto the transfer medium, pressing the intermediate transfer belt, onto which the color image is secondarily transferred, against the image bearing member of the monochrome-image forming unit and, in transferring the monochrome image onto the transfer medium, separating the intermediate transfer belt from the image bearing member of the monochrome-image forming unit.
